(19) United States
(12) Patent Application Publication
(10) Pub. No.: US 2014/0044033 A1
(43) Pub. Date: Feb. 13, 2014

(54) Apparatus and Method for Communication with a Number of User Equipments Using OFDMA

(71) Applicants: Daniele Molteni, Novara (IT); Mikko Saily, Helsinki (FI)

(72) Inventors: Daniele Molteni, Novara (IT); Mikko Saily, Helsinki (FI)

(73) Assignee: Nokia Siemens Networks Oy, Espoo (FI)

(21) Appl. No.: 14/113,592

(22) PCT Filed: Apr. 27, 2011
(86) PCT No.: PCT/EP2011/056659

§ 371 Date: Oct. 24, 2013

(51) Int. Cl. H04W 52/02

(52) U.S. Cl. CPC H04W 52/02
USPC 370/311

(57) ABSTRACT

Apparatus and method for communication are provided. The apparatus means for communicating with a number of user equipment using Orthogonal Frequency-Division Multiple Access connections on given data regions; means for selecting one or more data regions for each connection; and means for selecting the transmission power to be used on each connection, wherein the selection of data regions and powers is performed by minimising the total transmission power used on all connections while fulfilling the performance criteria of each connection.

### FIELD

The exemplary and non-limiting embodiments of the invention relate generally to wireless communication networks and, more particularly, to an apparatus and a method in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

Wireless communication systems are constantly under development. Developing systems provide a cost-effective support of high data rates and efficient resource utilization. One communication system under development is the 3rd Generation Partnership Project (3GPP) Long Term Evolution (LTE) Release 8. An improved version of the Long Term Evolution radio access system is called LTE-Advanced (LTE-A). The LTE and LTE-A are designed to support various services, such as high-speed data.

Some new wireless communication systems have adopted OFDMA (Orthogonal Frequency-Division Multiple Access) for data transmission. For example, the LTE deploys the OFDMA for the downlink transmission and single carrier frequency division multiple access (SC-FDMA) for the uplink transmission. The optimum allocation of radio resources is a common problem in all wireless communication systems, including systems utilizing OFDMA. In this context, the radio resources comprise the type and number of available channels and the transmission power used. The problem is to find a suitable association between current users and available radio resources on the basis of given optimality criterion. There are many factors which have an influence in the resource allocation, such as the varying path loss between transceivers and interference within a cell and between cells. Finding a correct solution for radio resource allocation may reduce the interference between connections and lead to energy savings in both base stations and user equipment.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus, comprising: at least one processor and at least one memory including a computer program code, the at least one memory and the computer program code configured to, with the at least one processor, cause the apparatus at least to: communicate with a number of user equipment using Orthogonal Frequency-Division Multiple Access connections on given data regions; select one or more data regions for each connection; select the transmission power to be used on each connection, wherein the selection of data regions and powers is performed by minimising the total transmission power used on all connections while fulfilling the performance criteria of each connection.

According to another aspect of the present invention, there is provided a method comprising: communicating with a number of user equipment using Orthogonal Frequency-Division Multiple Access connections on given data regions; selecting one or more data regions for each connection; and selecting the transmission power to be used on each connection, wherein the selection of data regions and powers is performed by minimising the total transmission power used on all connections while fulfilling the performance criteria of each connection.

According to an aspect of the present invention, there is provided an apparatus comprising: means for communicating with a number of user equipment using Orthogonal Frequency-Division Multiple Access connections on given data regions; means for selecting one or more data regions for each connection; and means for selecting the transmission power to be used on each connection, wherein the selection of data regions and powers is performed by minimising the total transmission power used on all connections while fulfilling the performance criteria of each connection.

According to another aspect of the invention, there is provided a computer program embodied on a distribution medium, comprising program instructions which, when loaded into an electronic apparatus, control the apparatus to: communicate with a number of user equipment using Orthogonal Frequency-Division Multiple Access connections on given data regions; select one or more data regions for each connection; select the transmission power to be used on each connection, wherein the selection of data regions and powers is performed by minimising the total transmission power used on all connections while fulfilling the performance criteria of each connection.

### LIST OF DRAWINGS

Embodiments of the present invention are described below, by way of example only, with reference to the accompanying drawings, in which

FIG. 1 illustrates an example of a radio system;

FIGS. 2A, 2B and 2C illustrate simplified examples of the downlink resource usage;

FIG. 3 illustrates an example of the interference level sensed by user equipment;

FIG. 4 illustrates an example of a perfect matching in a bipartite graph;

FIGS. 5A and 5B are flow charts illustrating embodiments of the invention; and

FIG. 6 illustrates an example of an eNodeB.

### DESCRIPTION OF SOME EMBODIMENTS

Exemplary embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments of present invention are applicable to any network element, node, base station, server, corresponding component, and/or to any communication system or any combination of different communication systems that support required functionalities. The communication system may be a wireless communication system or a communication system utilizing both fixed networks and wireless networks. The protocols used and the specifications of communication systems, servers and user terminals, especially in wireless communication, develop rapidly. Such development may require extra changes to an embodiment. Therefore, all words and expressions should be interpreted broadly and are intended to illustrate, not to restrict, the embodiment.

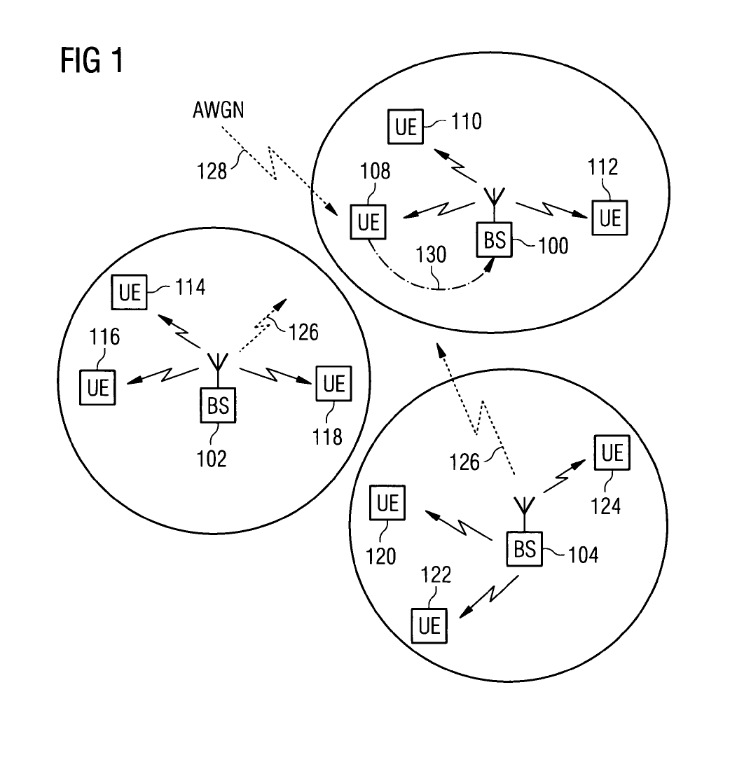

With reference to FIG. 1, let us examine an example of a radio system to which embodiments of the invention can be applied. In this example, the radio system is based on LTE network elements. However, the invention described in these examples is not limited to the LTE radio systems but can also be implemented in other radio systems.

FIG. 1 shows three base stations BS₀ 100, BS₁ 102, BS₂ 104 serving cells 100, 102, and 104. In this example, the base station 100 is communicating with user equipment 108, 110, 112, the base station 102 is communicating with user equipment 114, 116, 118 and the base station 104 is communicating with user equipment 120, 122, 124. Base stations that may also be called eNodeBs (Enhanced node Bs). The eNodeBs of the radio system may host the functions for Radio Resource Management: Radio Bearer Control, Radio Admission Control, Convection Mobility Control, Dynamic Resource Allocation (scheduling). User equipment refers to a portable computing device. Such computing devices include wireless mobile communication devices, including, but not limited to, the following types of devices: mobile phone, smartphone, personal digital assistant (PDA), handset, laptop computer. The apparatus may be battery powered.

FIG. 1 only illustrates a simplified example. In practice, the network may include more base stations and more cells may be formed by the base stations. The networks of two or more operators may overlap, the sizes and form of the cells may vary from what is depicted in FIG. 1, etc.

The embodiments are not restricted to the network given above as an example, but a person skilled in the art may apply the solution to other communication networks provided with the necessary properties. For example, the connections between different network elements may be realized with Internet Protocol (IP) connections.

The example system of FIG. 1 utilises OFDMA in the downlink direction from the base station to the user equipment. In OFDMA, the transmission frequency band is divided into multiple subcarriers orthogonal to each other. Each subcarrier may transmit data to specific user equipment. Thus, multiple access is achieved by assigning subsets of sub-carriers to any individual user equipment. All the considered cells share the same bandwidth leading to possible inter-cell interference. Let us consider an example, with N_{I} +1 cells gathered in a set K. Transmission is organized according to the frame structure composed by Z consecutive OFDM symbols defined over K_{T} available subcarriers. Multiple access transmission is handled by dividing the frame into gathered M data regions, each of them defined over K_{M}=K_{T}/M subcarriers and over the whole duration of the OFDMA frame. The set of regions indexes is denoted as M={1, . . . , M}. The generic mth data region (with m ∈ M) is defined by the set Fₘ={f₁, . . . , f_{K}_{_{M}}} of sub-carriers. Let us define Sₖ={MS₁, . . . , MS_{N}} as the set of N=|Sₖ| active users belonging to the kth cell, with N≦M and k ∈ K. We can define the cell load

$$η = \frac{N}{M} \leq 1$$

as the fraction of used resources within a cell.

The eNodeBs are configured to allocate one or more data re-gions for each user equipment. Without loss of generality, we consider in following that every user requests only one data region. Thus, the proposed scheduling algorithm assigns to each user one physical data region. The coded stream sent towards each user is assumed to be impaired by transmissions 126 of the nearby cells over the same physical data region and by background noise 128. The number of active transmissions impairing any data region ranges from 0 (no interference) to N_{I} (maximum interference) according to the scheduling strategies adopted in the interfering cells. Obviously, the more the traffic load grows the higher is the likelihood of having high number of interfering transmissions (e.g., for full traffic load in every cell we experience N_{I} interferers in every data region).

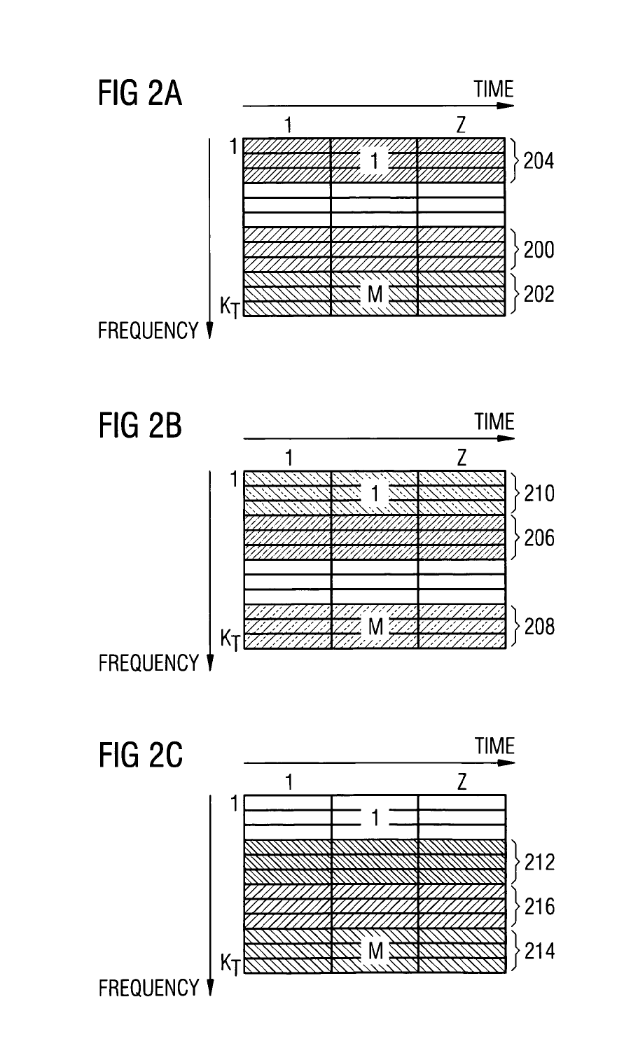

FIG. 2A illustrates a simplified example of the downlink resource usage in the cell 100 served by the BS₀ 100. FIG. 2A shows OFDMA frames comprising K_{T} subcarriers each carrying Z consecutive OFDM symbols. In this example, the frame is divided into M data regions each comprising three subcarriers. In the example of FIG. 1 and FIG. 2A, the BS₀ 100 has allocated data region 200 to the user equipment 108, data region 202 to the user equipment 110 and data region 204 to the user equipment 112.

FIG. 2B illustrates a simplified example of the downlink resource usage in the cell 102 served by the BS₁ 102. In the example of FIG. 1 and FIG. 2B, the BS₁ 102 has allocated data region 206 to the user equipment 114, data region 208 to the user equipment 116 and data region 210 to the user equipment 118. In a similar manner, FIG. 2C illustrates a simplified example of the downlink resource usage in the cell 104 served by the BS₂ 104. In the example of FIG. 1 and FIG. 2C, the BS₂ 104 has allocated data region 212 to the user equipment 120, data region 214 to the user equipment 122 and data region 216 to the user equipment 124.

In a downlink multicell environment, for a given user equipment, co-cell interference is generated by the eNodeBs in the nearby cells transmitting over the same subchannels. In an embodiment, the radio resource allocation is performed locally by each eNodeB of the system, optimizing the assignment for the users to the available subchannels.

Let us focus on the downlink transmission over one data region from the BS₀ 100 towards the generic ith user UEᵢ with i ∈ S₀. A sequence {bᵢ} of bits is coded, interleaved and mapped onto complex-valued symbols {xᵢ} defined for the considered digital modulation. The modulated signals are mapped over the mth physical data region allocated by the scheduler to the user MSᵢ. Each OFDM symbol of the frame is transmitted by the system over a frequency-selective fading channel impaired by AWGN 128 and inter-cell interference 126. Without any loss of generality, we focus on one OFDM symbol within the frame of Z symbols. The baseband signal over the kth sub-carrier is

yᵢ(k)=\sqrt{Pᵢ(m)}hᵢ(k)xᵢ(k)+w(k) (1)

where hᵢ(k) is the channel gain characterizing the link between BS₀ and the ith user, Pᵢ(m) is the transmitting power used over the whole mth data region. The subcarrier index k ranges over the subcarriers k ∈ Fₘ. The interference term w(k) is here modelled as AWGN with overall power σᵢ²(m)=E[|w(k)|²] that models the average (with respect to fading) interference power sensed by the ith user over the mth data region. The channel gain hᵢ(k) can be expressed as

$${h}_{i} ( k ) = \frac{{α}_{i} ( k )}{{d}_{i}^{β / 2}} , \qquad ( 2 )$$

where αᵢ(k) denotes the normalized fading channel such that E[|αᵢ(k)|²]=1. The distance between MSᵢ and BS₀ is denoted as dᵢ and the path loss exponent is β (typical values range from 2 to 4).

In an embodiment, only second order statistics of the radio channel are taken into account in the resource allocation. The signal to noise ratio SINR over the mth data region is averaged over channel and interference statistics. The average SINR over the whole mth logical channel may be defined as

$${γ}_{i} ( m ) = \frac{{P}_{i} ( m ) {g}_{i} ( m )}{{σ}_{i}^{2} ( m )} \qquad ( 3 )$$

where the channel gain gᵢ(m)=Eₖ[|hᵢ(k)|²] is the average gain over the mth data region. For a given candidate association between the ith user and the mth subchannel, the user equipment receiver performance (expressed as BER) can be drawn as a given function f(•) of the SINR γᵢ(m) so that BERᵢ=f(γᵢ(m)). The performance is strongly not linear and it depends on the adopted channel coding, interleaving, interference characterization and propagation environment (e.g., channel multi-path structure, diversity provided by the channel, etc.). The function f(•) is known at the eNodeB performing the scheduling. The function f(•) is thus a link performance curve that represents, for example, the BER or FER (Frame Error Rate) as a function of SINR. In an embodiment, a lookup table describing f(•) may be obtained through physical layer simulations.

The function should account for the specific transmitting environment (channel type, fading etc.) and the adopted modulation coding scheme.

The function f(.) is used to tune the power as the target BER is known. For example, if an application that requires a performance of BER=10⁻⁶ is used, a function f(.) (from a look up table, for instance) is used to assess the SINR that guarantees such BER for the considered communication environment. Once that the SINR target is obtained the transmitting power which reaches such SINR may be evaluated.

The total impairments

$${σ}_{i}^{2} ( m ) = {\sum }_{k ∈ K} {1}_{k} ( m ) \cdot {P}_{k} ( m ) {g}_{i , k} ( m ) + {σ}_{bn}^{2} \qquad ( 4 )$$

accounts for the average channel gain between the ith BS and the ith user g_{k,i}(m), the transmitting power adopted by the kth BS over the mth resource Pₖ(m). The on/off function 1ₖ(m) is defined as 1ₖ(m)=1 if the mth resource is employed by the kth BS and 0 otherwise. Finally σ_{bn}² is the power of the background noise.

It should be noted that the above equations are for example only. Embodiments of the invention are not limited to above mentioned models. In real life situations the channel and the interference may be different. Explicit equations are not needed as numerical simulations or empirical analysis may be utilized as well to obtain required information.

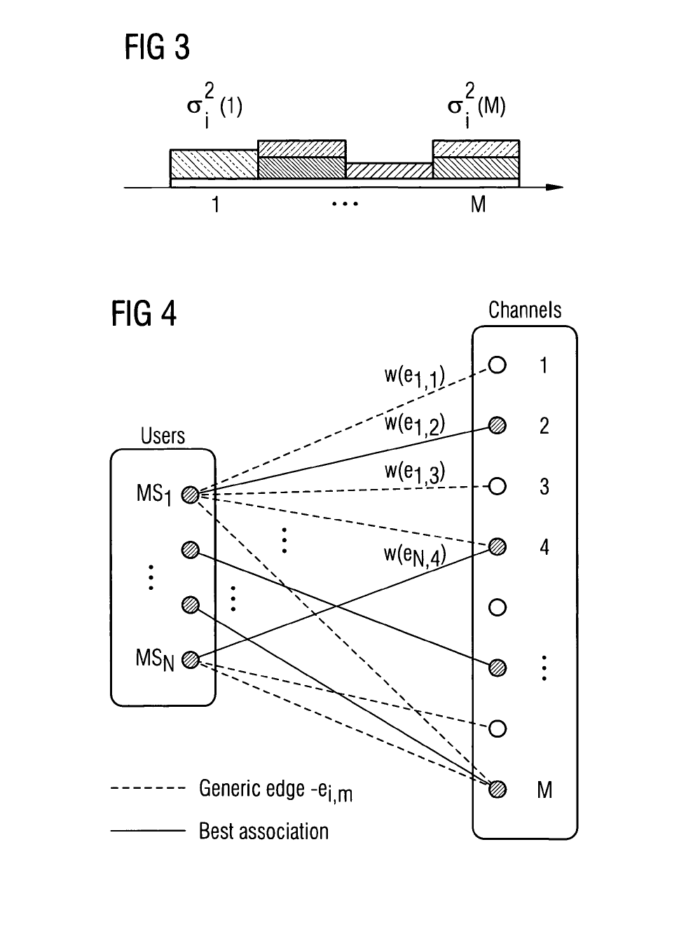

FIG. 3 illustrates an example of the interference level sensed by ith user. As depicted in FIG. 3, for a given user, the variations of channel gains {g_{i,k}(m)}_{k∈ K} and transmitting powers {Pₖ(m)}_{k∈ K} between different BSs generate strong interference fluctuations along the data regions M. Thus the spectrum presents different interference levels σᵢ²(m) from data region to data region and from MS to MS. This effect is even more strong in case the cells experience a small number of active users (i.e., limited traffic load η<1) since some data regions might be unused.

Each user equipment MS is characterized by a minimum service quality associated with the particular application (such as voice, data transmissions, etc.) connected to the user. In practical systems such a requirement may be defined as a maximum required Bit Error Rate BER (BERᵢ) for the communication link. For a given system set-up and propagation environment, the service requirement of the ith user may be modeled with a minimum SINR target γ̅ᵢ. Exploiting the parametrization introduced in above, the target SINR can be expressed as γ̅ᵢ=f⁻¹( B̅E̅R̅ᵢ̅) . Look up tables may be utilized to assess the SINR for a BER target.

Each user equipment MS may be configured to evaluate the level of interference over each logical channel but not the links that are responsible for the experienced level of interference. The interference is here characterized by long term statistics as the average power. It may be assumed that each MS is allowed to provide through a feedback channel 130 the interference level sensed on all the set of data regions (or on a predefined subset). It is clear that different and heterogeneous type of feedbacks can be used as, for example, the interference power or signal strength or the SINR level sensed over the data regions. In an embodiment, the generic ith user is supposed to forward the vector δᵢ=[δᵢ(1), . . . , δᵢ(M)] gathering the normalized SINRs

$${δ}_{i} ( m ) = \frac{{g}_{i} ( m )}{{σ}_{i}^{2} ( m )} \qquad ( 5 )$$

over the M data regions. As stated above, due to the differences of channel gains and transmitting powers relative to the interfering signals, the interference level fluctuates along the data regions. Thus, these fluctuations are reflected in the entries of δᵢ.

It is clear that embodiments of the invention can be adapted to a different type of feedback (for example when the set of interference powers δᵢ(m) is provided).

In an embodiment of the invention, optimum association between active users and available data regions are determined. Examples of possible optimality criterions are a) the minimum overall transmitting power under service requirements constraints or b) the maximum sum-capacity under total power budget. The transmitting power refers to the overall power required by the eNodeB to transmit to all the users. An example of a service requirement refers to maximum bit error rate allowed for a given link.

The power minimization directly reflects in a reduction of the generated interference towards the neighbour cells and energy savings.

In an embodiment, the proposed method provides the optimum association between users and data regions and the optimum power control solution for the given association. The optimality may be defined as the minimum overall transmitted sum-power at cell level for the downlink with performance constraints.

In another embodiment, the proposed method aims to maximize the overall cell capacity with a given total power constraint. Thus, given the total transmission power allowed for the eNodeB, the purpose is to maximize the cell capacity taking the service requirements constraints of each user equipment into account.

In an embodiment, each user equipment communicating with an eNodeB is configured to transmit to the eNodeB through a feedback channel Channel State Information (CSI) about the M subchannels. The CSI may be defined as signal to noise ration (SINR), noise level or signal strength over each subchannel. Each user equipment may be configured to measure and report the CSI for all the data regions in the cell, regardless whether the data region is assigned to that specific user equipment, is unassigned or assigned to other in-cell users. The CSI may be averaged over the channel fading and interference fluctuations (i.e., averaged over a number of consecutive frames).

In an embodiment, a trade-off may be made between the algorithm performance and required CSI report bandwidth. In such a case each user equipment may be configured to measure and report only a sub-set of the data regions.

Embodiments of the proposed invention comprise a resource allocation algorithm to be locally performed on the eNodeB. However, the same approach can also be applied to a multicell scenario where all eNodeBs are adopting the same optimization procedure.

In the following a resource allocation algorithm for a single cell is described first. Next, the same solution is extended to a multi-cell environment. If the solution is performed in a distributed fashion accounting for multiple eNodeBs the proposed methodology converges to the optimum at the system level (if it exists).

For the kth BS, the resource allocation problem consists in the association between users Sₖ and data regions M. Let aᵢ={MSᵢ,m} indicate that the user MSᵢ is associated to the mth data region, with MSᵢ ∈ Sₖ and m ∈ M. The target of the algorithm is to find the optimum association Aₖ={a₁, . . . , a_{N}} between the N users and the M data regions so that Aₖ ∈ Θ where Θ gathers the total

$$\vert Θ \vert = \frac{M !}{( M - N ) !}$$

possible combinations. Within each cell, the radio resources are used only by one single user (no intra-cell frequency reuse is allowed) so that aᵢ ∩ aⱼ=Ø, ∀{i, j} ∈ Sₖ and i=j.

The algorithm performed by the BS aims at minimizing a global cost function U(A) which depends on the resource allocation strategy A={a₁, . . . , a_{N}}. Here, the resource assignment is performed exploiting the set {δₖ}ᵢ₋₁^{N} of feedbacks of equation (5) provided by the N users. In an embodiment, the fluctuations of the SINRs value δᵢ are exploited along the data regions for every user. The strategy is to allocate the users to the data regions that show the best conditions (e.g., minimum interference level). In a multi-user access scenario a given data region can be the best choice for more than one user. Thus from a cell level perspective the optimum solution is represented by the combination of resource allocations that provide the minimum cost for the whole system. In an embodiment, the optimization problem performed in the kth cell can be stated as:

$${A}_{k} = arg {min}_{A ∈ Θ} U ( A ) . \qquad ( 6 )$$

The definition of the cost function represents one of the main degree of freedom in the optimization problem. In the following, it is assumed that the global U(A) can be defined as the sum of the cost functions evaluated over all associations MS-data region, so that

$$U ( A ) = {\sum }_{i = 1}^{N} u ( {a}_{i} ) . \qquad ( 7 )$$

In an embodiment, the optimized association should be performed under the constraints

$$\{ \begin{matrix}{BER}_{i} \leq {\overline{BER}}_{i} , with ∀ i ∈ {S}_{k} \\ {P}_{i} ( m ) \leq {P}_{max} with ∀ a ∈ A\end{matrix} \qquad ( 8 )$$

where Pₘₐₓ is the maximum allowed transmitting power. The cost function u(aᵢ) of a given candidate association aᵢ={MSᵢ,m} can be cast according to different approaches, including required transmission power and capacity of the system, for example. In an embodiment, the power required to associate the user MSᵢ with the mth data region under the constraint (8) is used in the cost function. This alternative is studied below. Regardless the cost function definition, the solution of (6) is represented by the combinatorial optimization problem of a weighted (perfect) matching problem in bipartite graphs. FIG. 4 illustrates an example of a perfect matching in a bipartite graph. Every user should be associated to one channel. The optimum association is the one with minimum sum-weight. A graph can be constructed by considering the users Sₖ and the channels M as the two subsets of vertices fully connected with the set of directed edges E={e_{i,m}:(i ∈ S_{k,m} ∈ M), ∀i,m} of cardinality NM, as sketched in FIG. 4. The edge e_{i,m} is associated with the cost w(e_{i,m}) requested to associate the user i with the channel m. Each weight is defined as w(e_{i,m})=u(aᵢ) with aᵢ as the candidate association. Several algorithms can be adopted to solve this kind of problem: an optimal solution is represented by the Hungarian algorithm well known to one skilled in the art.

The outcome of the optimization is the strategy Aₖ which represents the combination of users and data regions with the minimum overall cost (7) required to establish the communications with all the users of the cell.

In an embodiment, the transmitted power

u(aᵢ)=Pᵢ(m) (9)

is employed as the cost function for the ith user on the candidate data region m. As discussed above, the constraint (8) can be remapped as the minimum required SINR so that γᵢ≧γᵢ, ∀i ∈ Sₖ. Through (3) we can obtain the transmitting power as

$${P}_{i} ( m ) = \frac{\overline{{γ}_{i}}}{{δ}_{i} ( m )} . \qquad ( 10 )$$

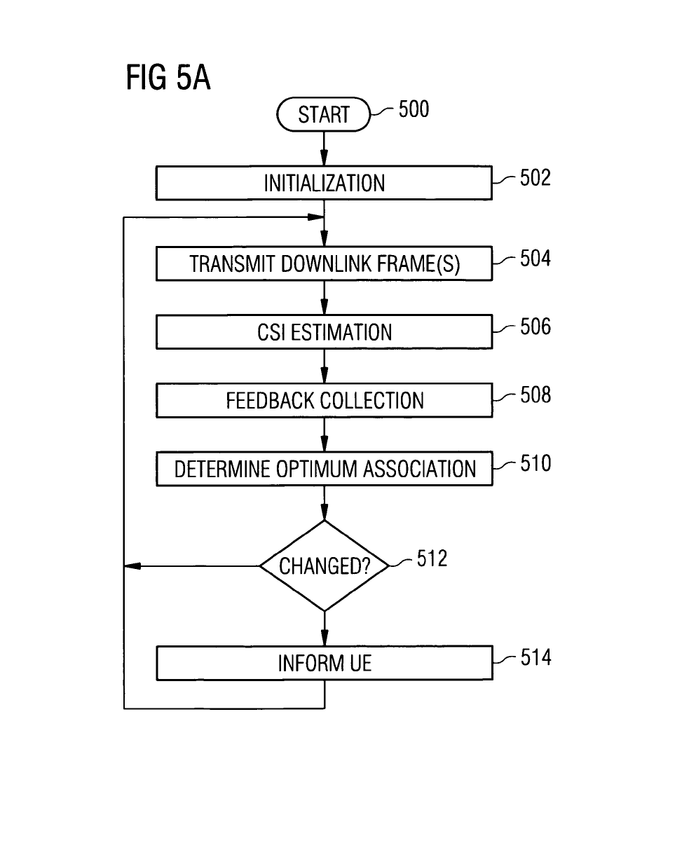

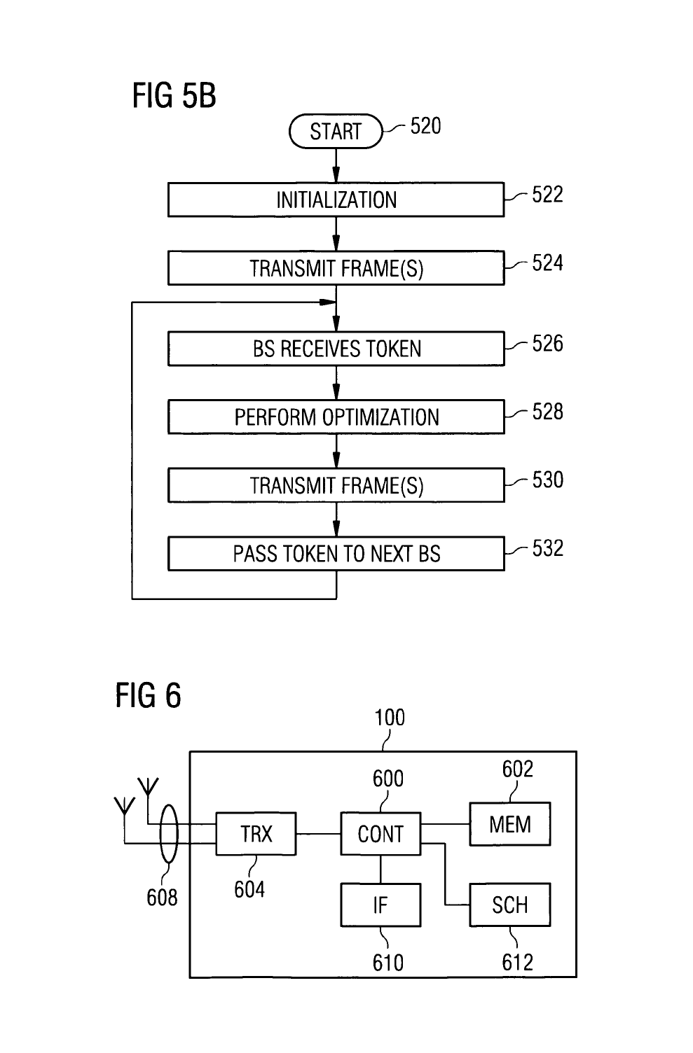

Here the power control is applied to compensate the channel gain by reaching the desired SINR. The constraint (8) relative to the maximum allowed power can be applied during the construction of the graph when Pᵢ(m) is evaluated. In case that Pᵢ(m)>Pₜₒₜ, the required SINR level γ̅ᵢ̅ can not be provided for the considered candidate pair aᵢ, thus the relative possible association should be removed from the graph. FIG. 5A is a flow chart illustrating an embodiment. The flow chart illustrates the phases of the iterative optimum subcarrier allocation and power control distributed algorithm. A solution for a single cell is described first.

Focusing on the kth cell, the base station has to establish the links with the users of the set Sₖ. The method may be denoted as a best-response approach since at each iteration of the optimization the base station chooses to transmit on the data regions that minimize its cost function thus maximizing its best-response strategy. The embodiment starts at step 500.

In step 502, initialization of the resource allocation is performed. In an embodiment, the base station of the system initializes the resource allocation by assigning to each user one channel randomly chosen among all the available channels. In an embodiment, the transmitting power is initialized with the maximum transmitting power. In the beginning, the initial channel assignment and transmitting powers are employed in the transmission of the frame(s). Since the allocation and the power assignments are not optimized, the initial performance (i.e., BER) of the users is not predictable and the service requirements of the users may not be satisfied in the beginning.

In step 504, the downlink frame or frames is/are transmitted.

In step 506, the user equipment (MS) in the multi-cell system estimates the CSI for the whole spectrum. Then, each MS updates the vector δᵢ gathering the SINRs values sensed over the M data regions.

In step 508, the base station receives through a feedback channel the CSI {δᵢ}_{i∈S}_{ₖ} from every user belonging to its cell. Furthermore each base station sets for every user the requested service target { γ̅ᵢ}_{i∈S}_{ₖ} as prescribed by the application or service used by the user and for the considered transmitting environment. The performances vary according to the required service or application. For example voice traffic requires a BER that can be different from web application or VoIP. Different BER means different SINR targets.

In step 510, a scheduler of the base station constructs the graph by calculating the NM edges w(e_{i,m}) for all combinations of i ∈ Sₖ and m ∈ M as depicted in FIG. 4. The scheduler solves the graph employing a combinatorial optimization algorithm. Possible algorithms are Hungarian, Gabow, and Dijkstra algorithms, for example. In addition, also sub-optimum algorithms can be employed to reduce the computational complexity of the optimal algorithm. One skilled in the art is aware that there exists many suitable algorithms suitable for the optimization task. The solution of the graph minimization gives the best association strategy Aₖ. Thus, a suitable data region for each MS is determined. In addition, the scheduler is configured to determine the transmitting powers Pᵢ for the selected associations so as to satisfy the requested service targets. Thus, the minimum downlink transmission power for each connection fulfilling the service requirements of each connection is determined.

In step 512, the base station compares the obtained sum power with the sum power of the previous resource allocation. If the sum power used previously is the same as the obtained value, the process continues in step 504.

If the sum power used previously is the greater than the obtained value, the base station changes the transmission policy according to the scheduler solution.

In step 514, the users are informed of the new resource allocation using the conventional signalling channels. For example, in the present LTE standard every transmitted downlink frame the users are informed where their data have been placed.

The process continues in step 504.

In an embodiment, the algorithm takes new users requiring for access into account by simply including the interference profiles of new users in the optimization procedure. The graph of FIG. 4 may be extended including one more users connected to the whole set of data regions. Thus at the first possible algorithm iteration, the new users are included in step 510 (i.e. the optimization algorithm is applied to the whole set of users including the “old” and “new” users) and the optimization is performed with the new value of N.

FIG. 5B is a flow chart illustrating an embodiment. A solution for a multi-cell cell is described. In a multi-cell system, each base station of the system may be configured to perform the above allocation method in an iterative distributed fashion. The resulting behaviour may be modelled as a non-cooperative game. The embodiment starts at step 520.

In step 522, initialization of the resource allocation is performed. Each base station of the system initializes the resource allocation by assigning to each user one channel randomly chosen among all the available channels. The transmitting power is initialized with the maximum transmitting power. In the beginning, the initial channel assignment and transmitting powers are employed in the transmission of the frame(s).

In step 524, the downlink frame or frames are transmitted.

In step 526, a base station of the system receives a token which informs the base station that it is its turn to perform optimization.

In step 528, the base station with the token performs the optimization procedure as described above in steps 506 to 512.

In step 530, a number of downlink frames are sent to let the users in the multi-cell system update their CSI. The number of frames sent may be predetermined.

In step 532, the token is passed to the next base station and the process continues in step 526.

The distributed procedure described above is designed to provide the optimum solution at the system level (if exists) after some iterations. The solution may be represented by the Nash equilibrium of the game and it is characterized by being stable and by reaching the overall minimum transmitting power for the whole system. The equilibrium is reached when there are any different association that can decrease the transmitting power.

The procedure requires coordination among the base stations to pass the token. The token can be distributed through a signalling channel among the base stations adopting a polling approach. Thus, simultaneous optimizing procedure of two or more base stations may be eliminated. The time between subsequent passings of the token may be predetermined.

In an embodiment, a polling approach is not utilized but the base stations are allowed to optimize the allocation at a random time. Even if the coordination (i.e., token) is not strictly required for the algorithm implementation, the presence of this light coordination among base stations guarantees that the equilibrium (if present) can be reached. Furthermore, it can be reached faster and with less iteration with respect to the random approach.

The reporting of the CSI from the user equipment to the base stations may be performed in many ways.

In an embodiment, the user equipment may report CSI periodically by sending subsets of CSI within each frame until CSI related to all data regions is transmitted. In an embodiment, a base station may request the user equipment the CSI of specific data region. In an embodiment, ad-hoc data compression and non-uniform quantization of CSI are utilised.

FIG. 6 illustrates an example of an eNodeB or a base station. The eNodeB 100 comprises a controller 600 operationally connected to a memory 602. The controller 600 controls the operation of the base station. The memory 602 is configured to store software and data. The eNodeB comprises a transceiver 604 is configured to set up and maintain a wireless connection to user equipment within the service area of the base station. The transceiver 604 is operationally connected the controller 600 and to an antenna arrangement 608. The antenna arrangement may comprise a set of antennas. The number of antennas may be two to four, for example. The number of antennas is not limited to any particular number.

The base station may be operationally connected to other network elements of the communication system. The network element may be an MME (Mobility Management Entity), an SAE GW (SAE Gateway), a radio network controller (RNC), another base station, a gateway, or a server, for example. The base station may be connected to more than one network element. The base station 100 may comprise an interface 610 configured to set up and maintain connections with the network elements. In an embodiment, the base station comprises a scheduler 612 configured to perform resource allocation and power control operations described above. The scheduler may be operationally connected to the controller and the memory.

The steps and related functions described above and in the attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as technology advances, the inventive concept can be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
communicate with a number of user equipment using Orthogonal Frequency-Division Multiple Access connections on given data regions;
select one or more data regions for each connection;
select the transmission power to be used on each connection, wherein the selection of data regions and powers is performed by minimising the total transmission power used on all connections while fulfilling the performance criteria of each connection.

2. The apparatus of claim 1, the apparatus being configured to:
receive channel state information measurements from each user equipment, and utilize the received channel state information when performing selections.

3. The apparatus of claim 2, wherein the channel state information received from the user equipment comprises measurement information from all data regions usable by the apparatus.

4. The apparatus of claim 1, wherein the apparatus is configured to receive from another apparatus a token indicating that it may start the selection process.

5. The apparatus of claim 1, wherein the apparatus is configured to send to another apparatus a token indicating that the other apparatus may start the selection process.

6. The apparatus of claim 1, wherein each data region comprises a given number of Orthogonal Frequency-Division Multiple Access subcarriers.

7. The apparatus of claim 1, wherein the apparatus is configured to determine for each user equipment with which it has a connection data regions fulfilling the service requirements of user equipment with a given transmission power, select for each user equipment one or more data regions from the determined data regions by minimizing the total transmission power used on all connections.

8. A method comprising:
communicating with a number of user equipment using Orthogonal Frequency-Division Multiple Access connections on given data regions;
selecting one or more data regions for each connection; and
selecting the transmission power to be used on each connection, wherein the selection of data regions and powers is performed by minimising the total transmission power used on all connections while fulfilling the performance criteria of each connection.

9. The method of claim 8, further comprising:
receiving channel state information measurements from each user equipment and utilizing the received channel state information when performing selections.

10. The method of claim 9, wherein the channel state information received from the user equipment comprises measurement information from all data regions usable by the apparatus.

11. The method of claim 8, further comprising: receiving from another apparatus a token indicating that it may start the selection process.

12. The method of claim 8, further comprising: sending to another apparatus a token indicating that the other apparatus may start the selection process.

13. The method of claim 8, wherein each data region comprises a given number of Orthogonal Frequency-Division Multiple Access subcarriers.

14. The method of claim 8, further comprising: a given set of apparatuses of a system communicating with a number of user equipment perform the selection of data regions and powers in a predetermined order with a predetermined time between the selections.

15. The method of claim 8, further comprising: a given set of apparatuses of a system communicating with a number of user equipment perform the selection of data regions and powers in random time instants relative to each other.

16. The method of claim 8, further comprising:
determining for each user equipment with which it has a connection data regions fulfilling the service requirements of user equipment with a given transmission power, and selecting for each user equipment one or more data regions from the determined data regions by minimizing the total transmission power used on all connections.

17. An apparatus comprising:
means for communicating with a number of user equipment using Orthogonal Frequency-Division Multiple Access connections on given data regions;
means for selecting one or more data regions for each connection; and
means for selecting the transmission power to be used on each connection, wherein the selection of data regions and powers is performed by minimising the total transmission power used on all connections while fulfilling the performance criteria of each connection.

18. A computer program embodied on a distribution medium, comprising program instructions which, when loaded into an electronic apparatus, control the apparatus to:
communicate with a number of user equipment using Orthogonal Frequency-Division Multiple Access connections on given data regions;
select one or more data regions for each connection;
select the transmission power to be used on each connection, wherein the selection of data regions and powers is performed by minimising the total transmission power used on all connections while fulfilling the performance criteria of each connection.
